(19) United States
(12) Patent Application Publication
(10) Pub. No.: US 2003/0150844 A1
(43) Pub. Date: Aug. 14, 2003

(54) Method and apparatus for laser welding hoses in an air induction system

(75) Inventor: James K. Vanderveen, Blenheim (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc.

(21) Appl. No.: 10/309,906

(22) Filed: Dec. 4, 2002

Related U.S. Application Data
(60) Provisional application No. 60/358,001, filed on Feb. 14, 2002.

(51) Int. Cl. B23K 26/00

(52) U.S. Cl. 219/121.6

(57) ABSTRACT

Laser welding is used to attach an air induction component to a hose member. The air induction component includes a wall with an opening that cooperates with the hose member. The hose member includes a flange that directly engages the wall of the induction component on a surface surrounding the opening. One of the hose or induction component is made from a laser transparent material and the other of the hose or induction component is formed from a laser absorbing material. Contour through transmission welding is used to generate a laser beam that passes through the transparent material, heats the absorbing material, which in turn heats the transparent material and forms a laser weld.

### CROSS-REFERENCE TO RELATED APPLICATIONS

The application claims priority to U.S. Provisional Application No. 60/358,001, which was filed on Feb. 14, 2002.

### BACKGROUND OF THE INVENTION

This invention generally relates to a method and system that uses laser welding for attachment of a hose to an air induction system component. Specifically, a hose is laser welded directly to the air induction system component without requiring a mating tube portion.

Typically, in an air induction system, hoses are attached to components such as air cleaners and resonators to provide a pathway for air moving through the air induction system. Traditionally, a tube member extends outwardly from the component and is attached to the hose with a metal clamp or an adhesive material.

These traditional attachment methods have several disadvantages. For example, additional materials are required such as a clamp member or an adhesive material that must be applied in an additional assembly step. These additional materials increase the overall weight and require time consuming assembly steps, which is undesirable.

Another disadvantage for a clamp attachment involves the interface between the tube and hose. The hose requires a wide flexible cuff and the mating tube member, over which the cuff is assembled, requires an increased wall thickness to accommodate material degradation that occurs under the clamp load. Another disadvantage with the adhesive material is that it is often messy and difficult to apply, resulting in an additional cleaning step during assembly.

One proposed solution is to use vibration welding to attach the hose to the tube. However, this technique requires relative motion between the hose and the tube to create friction, which heats up the materials to form the weld. Thus, apparatus is required to physically move at least one of the components, which can be undesirable if the components are large in size or complex in shape.

Thus, it is desirable to have a method and system that can attach a hose directly to an air induction system component by eliminating the need for an attachment interface with a tube member, as well as overcoming the other above mentioned deficiencies with the prior art.

### SUMMARY OF THE INVENTION

A method for attaching a first induction component to a second induction component in an air induction system includes positioning a first induction component over an opening formed within a wall of a second induction component and laser welding the components together around the opening.

Preferably, the first induction component includes a flange that directly engages the wall of the second induction component. The wall includes an internal surface and an external surface. Depending upon the desired configuration, the flange directly engages the internal or external surface of the wall about the perimeter of the opening.

Preferably, one of the components is made from a polyolefin material or nylon material and the other of the components is made from an elastomeric material. Further, one of the materials is transparent to allow a laser beam to be directed through the transparent material of one component to the other component, which serves as an absorbing component. Thus, for example, if the elastomeric material is transparent then the transparent material is engaged against the internal or external surface of the wall of the polyolefin or nylon component. A laser beam is generated that passes through the transparent material, heats the absorbing component, which in turn heats the transparent material and forms the laser weld that attaches the components together. The components remain stationary while the laser beam travels with respect to the components.

In one disclosed embodiment, a transversely extending wall lip is formed about an opening in a wall of the resonator or air cleaner. A corresponding flange lip is formed at a distal end of the flange. The wall lip is received within the flange lip and the laser weld is applied along a direction generally parallel to the flange and wall lips.

The subject system and method provide a simple and effective attachment method for attaching an air induction components to a hose and which eliminates the need for an intermediary tube attachment for the induction component. These and other features of the present invention can be best understood from the following specifications and drawings, the following of which is a brief description.

### BRIEF DESCRIPTION OF THE DRAWINGS

FIG. 1 is a schematic environmental view of an air induction system incorporating the subject invention.

FIG. 2 is a cross-sectional view of an alternate embodiment of an air induction system incorporating the subject invention.

FIG. 3 is a cross-sectional view of an alternate embodiment of an air induction system incorporating the subject invention.

### DETAILED DESCRIPTION OF A PREFERRED EMBODIMENT

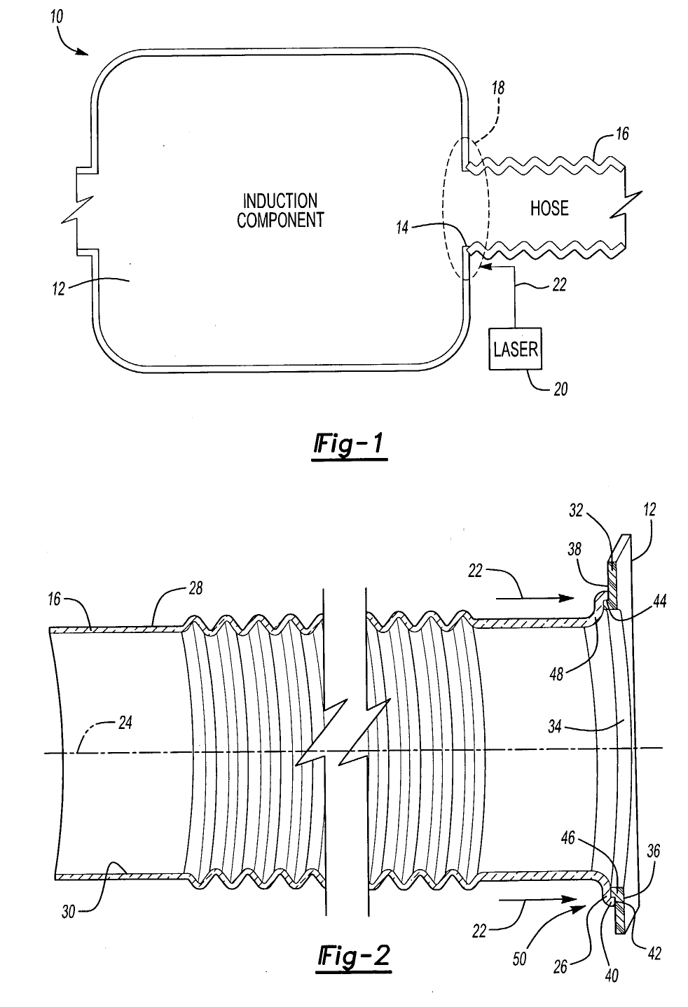

An air induction system is shown generally at 10 in FIG. 1. The air induction system 10 includes at least one air induction component 12 that defines an opening 14 for connection to a hose 16. The air induction component 12 can be any know induction component but is preferably a resonator or air cleaner the operation of which is well known in the art and will not be discussed in detail. Laser welding is directed at an attachment interface, indicated generally at 18, to attach the induction component 12 to the hose 16.

It should be understood that any type of laser welding process could be used to attach the hose 16 to the induction component 12. In the preferred embodiment, contour through transmission laser welding is used where a laser 20 generates a beam 22, which travels relative to the component 12 and hose 16. The beam 22 follows the contour of the attachment interface 18 to form the laser weld.

In the preferred embodiment, the induction component 12 is made from a polyolefin material and the hose 16 is made from an elastomeric material. While this combination is preferred, any type of polyolefin or nylon used in an air intake system with a compatible elastomeric material known in the art could be used.

In one embodiment, shown in FIG. 2, the hose 16 defines a central axis 24 and includes a flange 26 that extends transversely to the central axis 24. The hose 16 also includes an outer surface 28 and an inner surface 30. The induction component 12 includes a wall 32 that extends generally perpendicular to the central axis 24 and has an opening 34 that cooperates with the hose 16 for air transfer. The wall 32 has an inner surface 36 and an outer surface 38.

In the embodiment of FIG. 2, the flange 26 directly engages the outer surface 38 of the wall 32 about the perimeter surface surrounding the opening 34. The flange 26 includes a distal flange lip 40 that has an end face 42 and an inner surface 44. The distal flange lip 40 is formed transversely to the body of the flange 26 and extends generally parallel to the central axis 24. A corresponding wall lip 46 is formed about the perimeter of the opening 34. The inner surface 44 directly engages the wall lip 46 and the end face 42 directly engages the outer surface 38 of the wall 32. A radiused region 48 transitions from the main tube 16 to the flange 26 to improve air flow into the induction component 12. The laser beam 22 is applied along a path generally parallel to the central axis 24 to form a laser weld at an attachment interface, shown generally at 50.

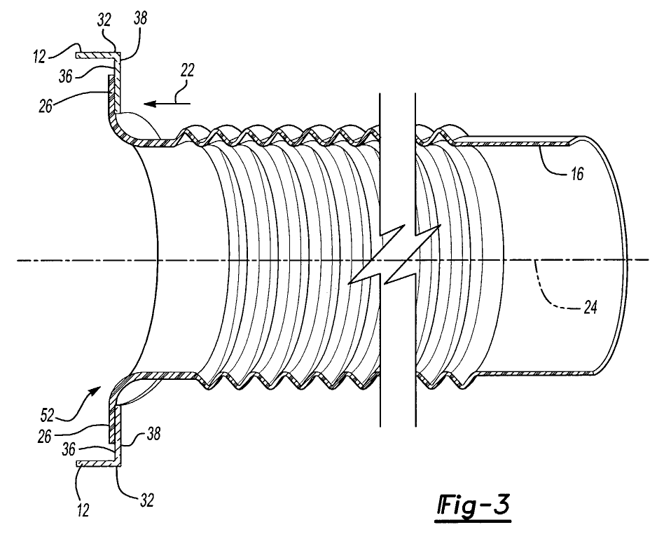

In the embodiment of FIG. 3, the flange 26 directly engages the inner surface 36 of the wall 32. In the embodiment of FIG. 3, the laser beam 22 is applied along a path generally parallel to the central axis 24 to form a laser weld at the attachment interface, shown generally at 52.

While the flange 36 in the embodiment of FIG. 3 does not include a flange lip 40 as described above, it should be understood that a similar wall lip 46 could be formed on the inner surface 36 of the wall to mate with a flange lip 40. It should also be understood that a flange embodiment similar to that of FIG. 3, i.e., a flange with no lip, could also be used in the configuration in FIG. 2. The interaction between flange lip 40 and wall lip 46 provides an interference type fit prior to the laser welding step, which facilitates positioning and holding the hose 16 and induction component 12 at proper orientation with respect to each other during the welding process. It should be under stood that any type of known interference or snap fit could be used to hold or lock the hose 16 to the mating induction component 12 in order to achieve the desired 360 degree contact about the opening 34.

To facilitate the laser welding process, one of the hose 16 or induction component 12 is formed from a laser transparent material while the other of the hose 16 or induction component 12 comprises a laser absorbing material. The application direction of the laser beam 22 depends on which component is formed from the transparent material and whether the flange 26 of the hose 16 is mounted internally or externally to the wall 32. The laser beam 22 is transmitted through the transparent material to first heat the absorbing material. As the temperature of the absorbing material increases, the transparent material also experiences a temperature increase. The temperature increase cause localized melting of both materials, which in turn forms the laser weld.

For example, assume that the hose 16 is formed from a transparent material and the induction component 12 is formed from the absorbing material. In the embodiment of FIG. 2, the flange 26 engages the outer surface 38 of the wall. Thus, the laser beam 22 would be applied along a path external to the induction component 12, i.e. the laser beam 22 would be transmitted first through the transparent flange 26 and then into the absorbing wall 32. The laser beam 22 travels around the entire attachment interface 50 while the hose 16 and induction component 12 remain stationary. The laser beam 22 generally extends in a direction parallel to the central axis 24.

In the embodiment of FIG. 3, the flange 26 engages the inner surface 36 of the wall 32. Thus, the laser beam 22 would be applied along a path internal to the induction component 12, i.e. the laser beam 22 would be transmitted first through the transparent flange 26 and then into the absorbing wall 32.

If the reverse configuration is used, i.e. if the induction component 12 is formed from the transparent material and the hose 16 is formed of the absorbing material, than the laser beam 22 is applied in a manner opposite to that above. In the embodiment of FIG. 2, the flange 36 engages the outer surface 38 of the wall so the laser beam 22 would be applied along a path internal to the induction component 12. In the embodiment of FIG. 3, the flange 26 engages the inner surface 36 of the wall 32 so the laser beam 22 would be applied along a path external to the induction component 12.

The subject invention provides direct attachment of a hose 16 to an air induction component 12 without requiring an intermediary tube member attached to the induction component. Thus, there is no overlap between a hose and a tube, which equates to a materials savings and the elimination of fit and assembly issues between the hose and the tube. Additional components, such as the clamp and the associated hardware are also eliminated by using the laser welding method described above. Air flow into the induction component is also improved due to the radius transition region 48 located between the tube 16 and the flange 26.

Also, by using laser welding, the subject invention allows non-circular hoses 16 to be used, resulting in more design freedom for different vehicle configurations. The shape of the hose is an important consideration when trying to lower hood lines because a lower profile reduces packaging space in the engine compartment. Thus, elliptical tubes can now be used without the design and assembly problems caused by elliptical clamps.

An additional benefit of the subject invention is that the hose can be installed from the inside or outside of the induction component 12. Thus, as described above, depending on where the flange 26 is positioned relative to the wall 32 and depending on which material is laser transparent, the direction of laser welding can occur internally or externally with respect to the induction component 12.

Another benefit is that smaller tubes, such as vacuum tubes on the air cleaner, resonator, or manifold, could also be laser welded. As discussed above, the materials would have to be compatible with one of the tubes or induction components (resonator, manifold, air cleaner) being a laser transparent material.

The subject provides have a method and system that attaches a hose 16 to an air induction system component 12 that does not require the components or hoses to be moved during attachment with the additional benefits of reducing the overall weight of the assembly and eliminating extra attachment hardware

Although a preferred embodiment of this invention has been disclosed, a worker of ordinary skill in this art would recognize that certain modifications would come within the scope of this invention. For that reason, the following claims should be studied to determine the true scope and content of this invention.

1. An air induction system comprising:
a first component having a wall with an opening;
a second component engaging said wall at an attachment interface surrounding said opening; and
a laser weld area formed at said attachment interface for securely attaching said first and second components together.

2. An air induction system as set forth in claim 1 wherein said first component comprises a polyolefin material and said second component comprises an elastomeric material.

3. An air induction system as set forth in claim 1 wherein said second component comprises a hose defining a central axis and having a pair of hose ends.

4. An air induction system as set forth in claim 3 wherein at least one of said hose ends includes a flange extending transversely to said central axis.

5. An air induction system as set forth in claim 4 wherein said wall includes an internal surface and an external surface extending transversely to said central axis and wherein said flange directly engages said external surface around the perimeter of said opening.

6. An air induction system as set forth in claim 5 wherein said flange includes a flange lip extending generally parallel to said central axis and having an internal lip surface and a distal end face and wherein said wall includes a transversely extending wall lip surrounding said opening, said internal lip surface engaging said wall lip and said distal end face engaging said external surface of said wall.

7. An air induction system as set forth in claim 6 wherein a laser beam forms said laser weld area with said laser beam being transmitted toward said flange along a path generally parallel to said central axis.

8. An air induction system as set forth in claim 4 wherein said wall includes an internal surface and an external surface extending transversely to said central axis and wherein said flange directly engages said internal surface around the perimeter of said opening.

9. An air induction system as set forth in claim 3 wherein one of said first component or said hose comprises a laser transparent material.

10. An air induction system as set forth in claim 9 wherein the other of said first component or said hose comprises a laser absorbing material.

11. An air induction system as set forth in claim 10 wherein a laser beam is directed toward said laser transparent material to first heat said other of said first member or said hose resulting in subsequent heating of said transparent material to form said laser weld area.

12. An air induction system as set forth in claim 1 wherein said first component comprises a resonator and said second component comprises a hose.

13. An air induction system as set forth in claim 1 wherein said first component comprises an air cleaner and said second component comprises a hose.

14. An air induction system comprising:
an induction component made from a polyolefin material and having a wall with an opening;
a hose made from an elastomeric material and defining a central axis, said hose including a flange formed about one hose end wherein said flange directly engages said wall around a perimeter of said opening to define an attachment interface; and
a laser weld area formed at said attachment interface to securely attach said hose to said induction component.

15. An air induction system as set forth in claim 14 said hose comprises a laser transparent material and said induction component comprises a laser absorbing material.

16. An air induction system as set forth in claim 15 wherein said flange engages an external surface of said wall such that a laser beam forms said laser weld area by being transmitted along a path generally parallel to said central axis external to said induction component.

17. An air induction system as set forth in claim 15 wherein said flange engages an internal surface of said wall such that a laser beam forms said laser weld area by being transmitted along a path generally parallel to said central axis internal to said induction component.

18. An air induction system as set forth in claim 14 wherein said induction component comprises a laser transparent material and said hose comprises a laser absorbing material.

19. An air induction system as set forth in claim 18 wherein said flange engages an external surface of said wall such that a laser beam forms said laser weld area by being transmitted along a path generally parallel to said central axis internal to said induction component.

20. An air induction system as set forth in claim 18 wherein said flange engages an internal surface of said wall such that a laser beam forms said laser weld area by being transmitted along a path generally parallel to said central axis external to said induction component.

21. An air induction system as set forth in claim 14 wherein said hose includes a noncircular cross-section.

22. An air induction system as set forth in claim 14 wherein said hose transitions into said flange via a curved surface.

23. A method for attaching a first induction component to a second induction component in an air induction system comprising the steps of:
positioning a first induction component over an opening formed within a wall of a second induction component; and
laser welding the first and second induction components together.

24. A method as set forth in claim 23 wherein said first induction component comprises a hose and said second induction component comprises a resonator or air cleaner.

25. A method as set forth in claim 23 including the steps of forming the second induction component from a polyolefin material and the first induction component from an elastomeric material.

26. A method as set forth in claim 23 including the step of forming one of the first or second induction components from a laser transparent material with the other of the first or second induction components comprising a laser absorbing material.

27. A method as set forth in claim 26 including the steps of directing a laser beam through the transparent material to first heat the laser absorbing material with subsequent heating of the transparent material to generate a laser weld.

28. A method as set forth in claim 27 including the step of directing the laser beam along a path internal to the second induction component.

29. A method as set forth in claim 27 including the step of directing the laser beam along a path external to the second induction component.

30. A method as set forth in claim 23 including the steps of forming a flange at one end of the first induction component and directly engaging the flange against the wall of the second induction component about an external surface surrounding the opening.

31. A method as set forth in claim 23 including the steps of forming a flange at one end of the first induction component and directly engaging the flange against the wall of the second induction component about an internal surface surrounding the opening.
